(19) United States
(12) Patent Application Publication
(10) Pub. No.: US 2025/0108958 A1
(43) Pub. Date: Apr. 3, 2025

(54) STACKABLE STORAGE CONTAINERS

(71) Applicant: AOB Products Company, Columbia, MO (US)

(72) Inventors: Daniel Jennings, Columbia, MO (US); Michael Cottrell, Ashland, MO (US); Michael Lindsay, Columbia, MO (US)

(73) Assignee: AOB Products Company, Columbia, MO (US)

(21) Appl. No.: 18/901,176

(22) Filed: Sep. 30, 2024

Related U.S. Application Data
(60) Provisional application No. 63/541,672, filed on Sep. 29, 2023.

(51) Int. Cl. B65D 21/02; B25H 3/02

(52) U.S. Cl. CPC B65D 21/0223; B25H 3/02

(57) ABSTRACT

A stackable container system and associated components and methods. The stackable container system includes a variety of containers arrangeable in different stacked arrangements. The containers include mating structure configured to enable nesting of the containers in various stacked arrangements. The mating structure is configured to facilitate nesting of containers of different sizes on top of each other.

### CROSS-REFERENCE TO RELATED APPLICATION

This application claims priority to U.S. Provisional Application No. 63/541,672, filed Sep. 29, 2023, the entirety of which is hereby incorporated by reference.

### FIELD

The present disclosure generally relates to storage containers, and more particularly to storage containers that are stackable.

### BACKGROUND

Storage containers are used to hold various items, such as tools, equipment, devices, etc.

### SUMMARY

In one aspect, a container system comprises a first storage container, a second storage container, and a third storage container. The first storage container includes a first base, a first lid, and a first storage interior defined by the first base and the first lid. The first base forms a bottom of the first storage container and the first lid forms a top of the first storage container. The first base includes a first mating recess on the bottom of the first storage container. The first lid includes a first mating projection on the top of the first storage container. The first storage container is of a first size. The second storage container includes a second base, a second lid, and a second storage interior defined by the second base and the second lid. The second base forms a bottom of the second storage container and the second lid forms a top of the second storage container. The second base includes a second mating recess on the bottom of the second storage container. The second lid includes a second mating projection on the top of the second storage container. The second storage container is of a second size different than the first size. The third storage container includes a third base, a third lid, and a third storage interior defined by the third base and the third lid. The third base forms a bottom of the third storage container and the third lid forms a top of the third storage container. The third lid includes a plurality of third mating projections on the top of the third storage container. The third storage container is of a third size different than the second size and the first size. The first, second, and third storage containers are configured to be arranged in a first stacked arrangement and a second stacked arrangement. In the first stacked arrangement, the second storage container is stacked on the third storage container such that two third mating projections of the plurality of mating projections of the third storage container are disposed in the second mating recess of the second storage container, and the first storage container is stacked on the third storage container such that another two third mating projections of the plurality of mating projections of the third storage container are disposed in the first mating recess of the first storage container. In the second stacked arrangement, the second storage container is stacked on the third storage container such that two third mating projections of the plurality of mating projections of the third storage container are disposed in the second mating recess of the second storage container, and the first storage container is stacked on the second storage container such that the second mating projection of the second storage container is disposed in the first mating recess of the first storage container.

Other objects and features of the present disclosure will be in part apparent and in part pointed out herein.

### BRIEF DESCRIPTION OF THE DRAWINGS

FIG. 1 is a perspective of a container system in one possible stacked arrangement according to the present disclosure;

FIG. 2 is a top perspective of a large size container of the container system;

FIG. 3 is a bottom perspective of the large size container;

FIG. 4 is a plan view of the large size container;

FIG. 5 is a perspective of the large size container with a lid thereof in an open position;

FIG. 6 is a top perspective of a medium size container of the container system;

FIG. 7 is a bottom perspective of the medium size container;

FIG. 8 is a plan view of the medium size container;

FIG. 9 is a perspective of the medium size container with a lid thereof in an open position;

FIG. 10 is a perspective of a base of the medium size container stacked on the large size container, the base being transparent to show the mating of the containers;

FIG. 11 is a top perspective of a small size container of the container system;

FIG. 12 is a bottom perspective of the small size container;

FIG. 13 is a plan view of the small size container;

FIG. 14 is a perspective of the small size container with a lid thereof in an open position;

FIG. 15 is a perspective of a base of the small size container stacked on the medium size container, the base being transparent to show the mating of the containers;

FIG. 16 is a perspective of the base of the small size container stacked on the large size container, the base being transparent to show the mating of the containers;

FIG. 17 is a top perspective of a jumbo medium size container of the container system;

FIG. 18 is a plan view of the jumbo medium size container;

FIG. 19 is a bottom perspective of the jumbo medium size container;

FIG. 20A is a perspective of the bases of two small size containers and the base of a medium size container stacked on the jumbo medium size container, the bases being transparent to show the mating of the containers;

FIG. 20B is a perspective of the base of a medium size container stacked on the container of FIG. 17 in a position different than FIG. 20A, the base being transparent to show the mating of the containers;

FIG. 21 is a top perspective of an extra-large size container of the container system;

FIG. 22 is a plan view of the extra-large size container;

FIG. 23 is a bottom perspective of the extra-large size container;

FIG. 24 is a perspective of the bases of each of a small, medium, and large size container stacked on the extra-large size container, the bases being transparent to show the mating of the containers;

FIGS. 25-28 are perspectives of the container system in other possible stacked arrangements according to the present disclosure.

Corresponding reference characters indicate corresponding parts throughout the drawings.

### DETAILED DESCRIPTION

The present disclosure relates to stackable storage containers of various sizes (e.g., two or more, such as three, four, five, etc.). The storage containers include locating structure on their tops and bottoms for engaging or mating with locating structure of other storage containers stacked above or below to position the storage containers relative to one another in the stack. This allows all the storage containers, regardless of size, to be stacked together, with each layer of storage containers in the stack being substantially within the footprint of the largest size of storage container. This ensures the vertical orientation of the stack of storage containers. The storage containers can be used to contain and store a variety of different items I (e.g., one or more items), such as tools (e.g., screwdriver, screwdriver bits, wrenches, firearm tools, etc.). Other items can be used without departing from the scope of the present disclosure.

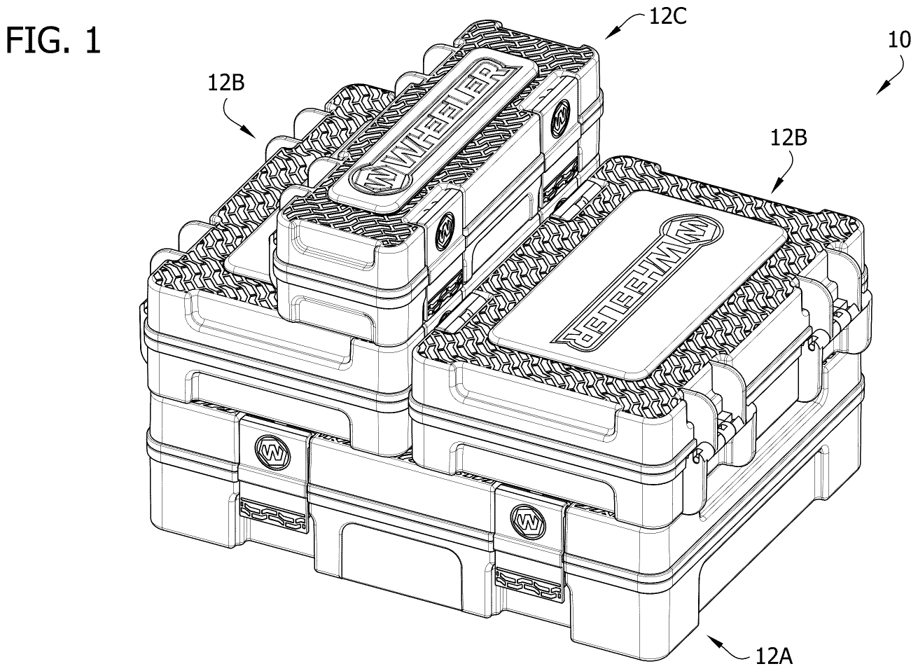

Referring to FIG. 1, a container system (“storage container system” or “system”) according to one embodiment of the present disclosure is generally indicated by reference numeral 10. The container system 10 includes a plurality (e.g., two or more) of storage containers 12A-E (“containers”). The storage containers 12A-E come in a variety of different sizes. In the illustrated embodiment, the containers 12A-E come in five different sizes: a large size storage container 12A (“large container”), a medium size storage container 12B (“medium container), a small size storage container 12C (“small container), a jumbo medium size container 12D (“jumbo medium container”), and an extra-large size container 12E (“extra-large container”) (e.g., first storage container, second storage container, a third storage container, etc.). Storage containers of other sizes may be used without departing from the scope of the present disclosure. Generally, the sizes (e.g., large, small, etc.) refer to the size of the footprint of each storage container 12A-E relative to the other storage containers. For example, the large size storage container 12A has a larger footprint (broadly, a larger size) than the medium size storage container 12B, which has a larger footprint (broadly, a larger size) than the small storage container. Each of the container 12A-E types have different sizes (e.g., first size, second size, third size, etc.). Specifically, each of the container 12A-E types have different footprint sizes (e.g., first footprint size, second footprint size, third footprint size, etc.). The extra-large container 12E is larger than the large container 12A, which is larger than the medium container 12B, which is larger than the small container 12C. In the illustrated embodiment, the jumbo medium container 12D is generally equivalent to two medium containers 12A placed longitudinally side-by-side. In one embodiment, as illustrated, the each of the container 12A-E types may be of the same height.

The various types or sizes of containers 12A-E of the present disclosure will now be described. As will become apparent, the containers 12A-E are all of similar construction. Accordingly, as used herein, when a reference character includes a reference numeral followed by a range of letters (e.g., “12A-E”), such a reference character refers to all elements designated at least in part by the reference numeral. Moreover, when a reference character includes the reference numeral flowed by a single letter, such as “A,” (e.g., “12A”) such a reference character refers to a particular element or sub-group of elements from the group of elements. For example, as used herein, reference character “12A-E” designates all storage containers, while reference character “12A” designates a specific storage container, in this case the large storage container.

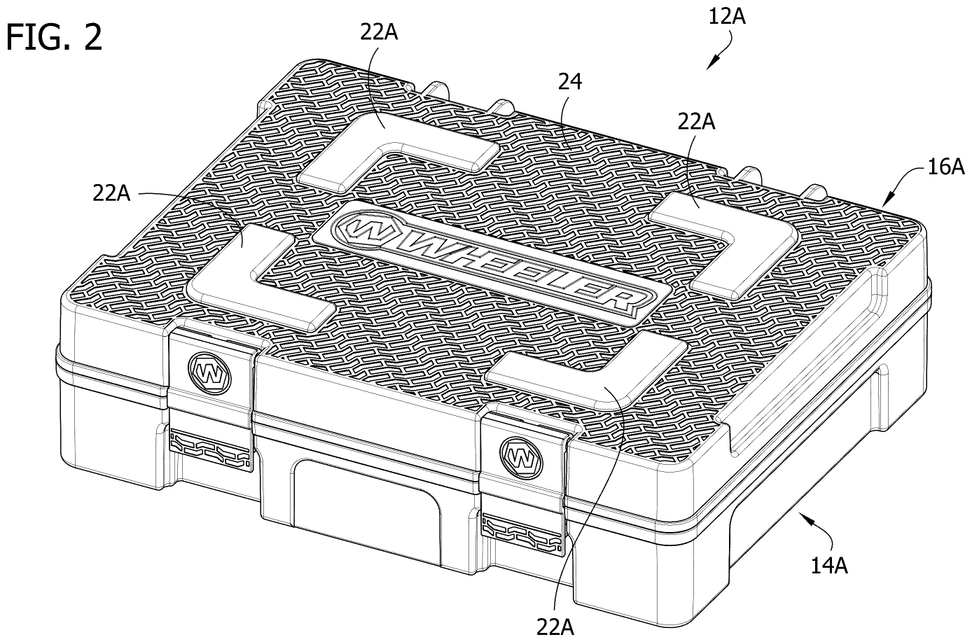

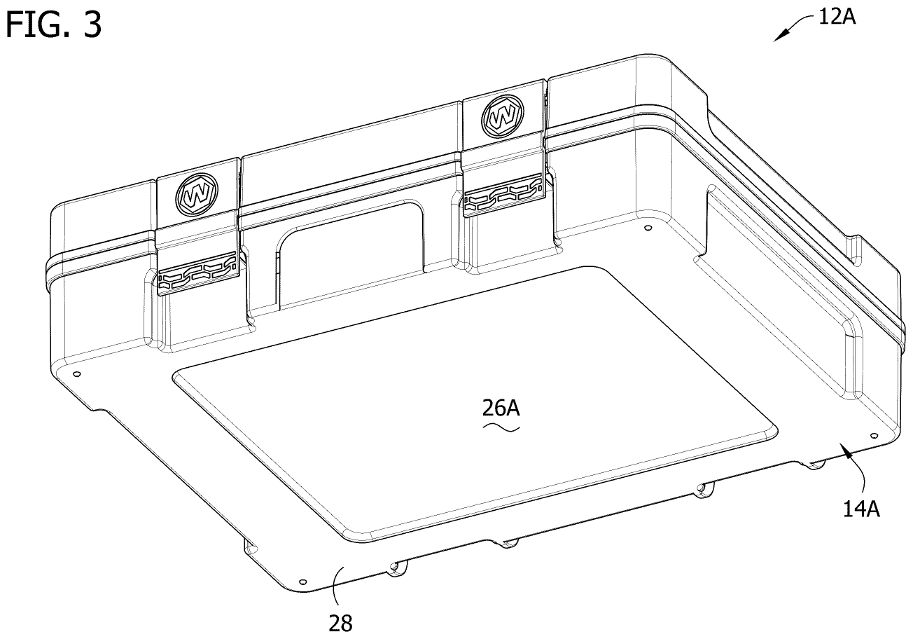

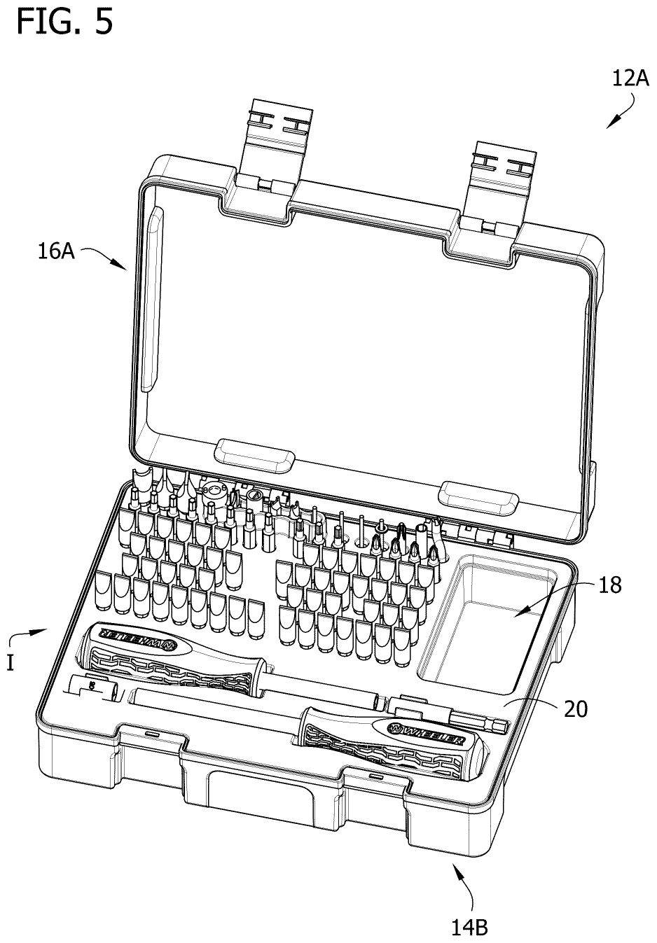

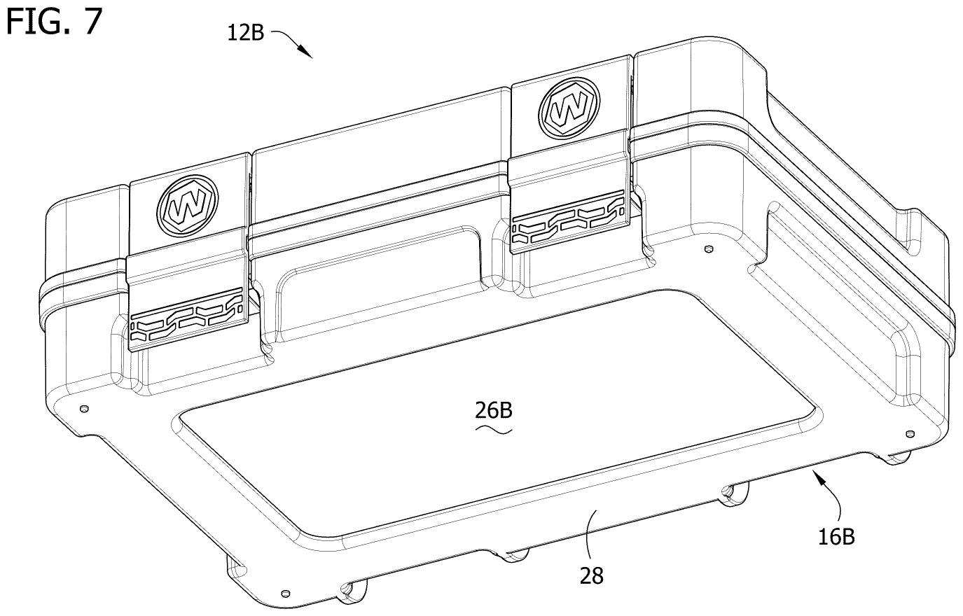

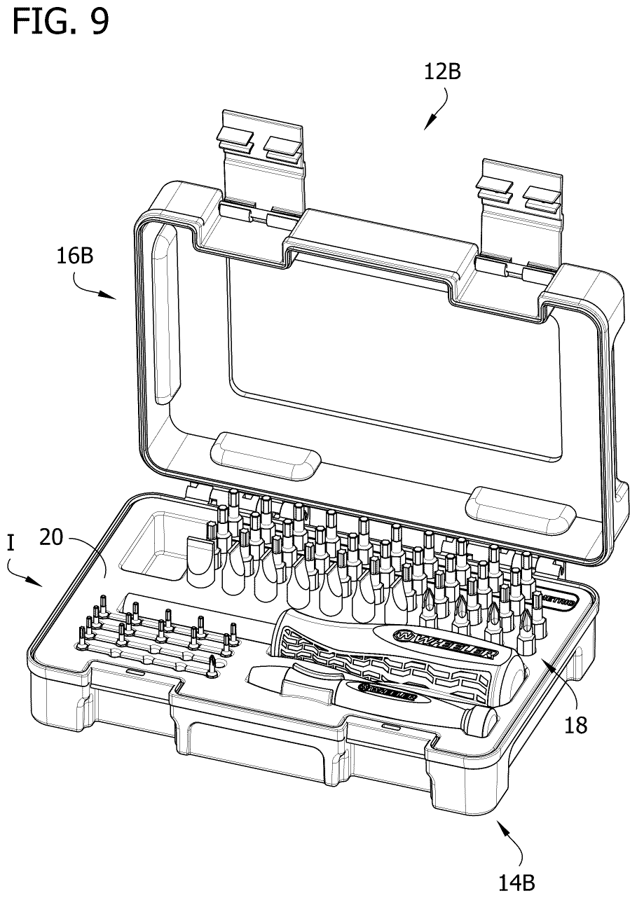

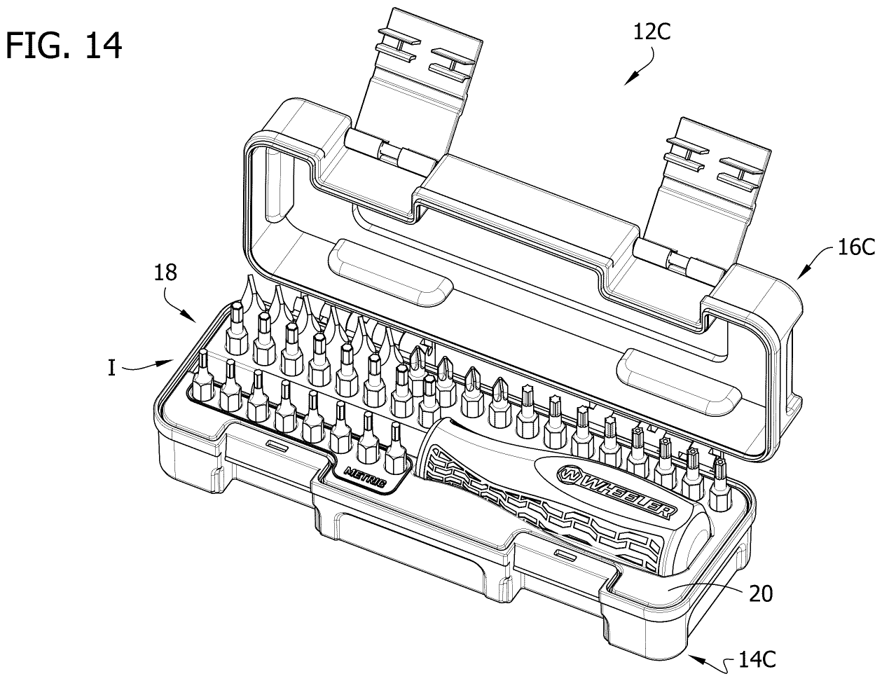

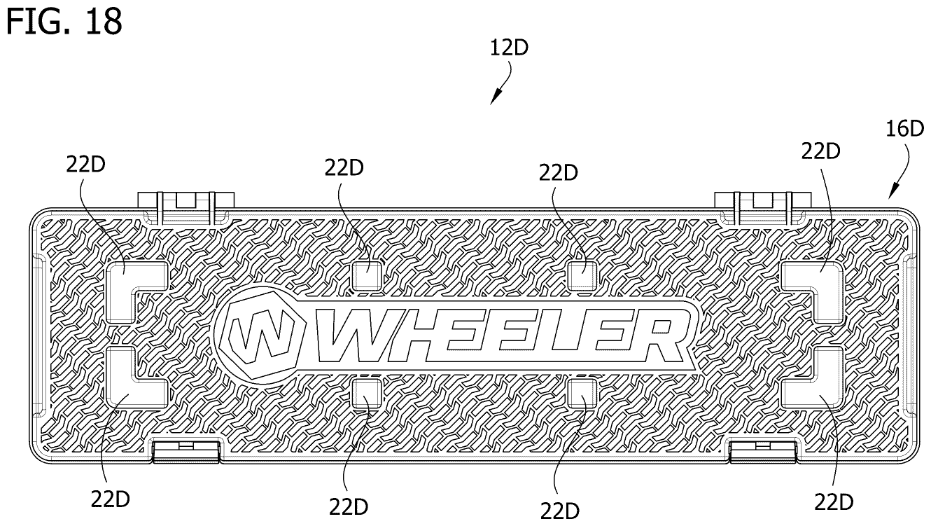

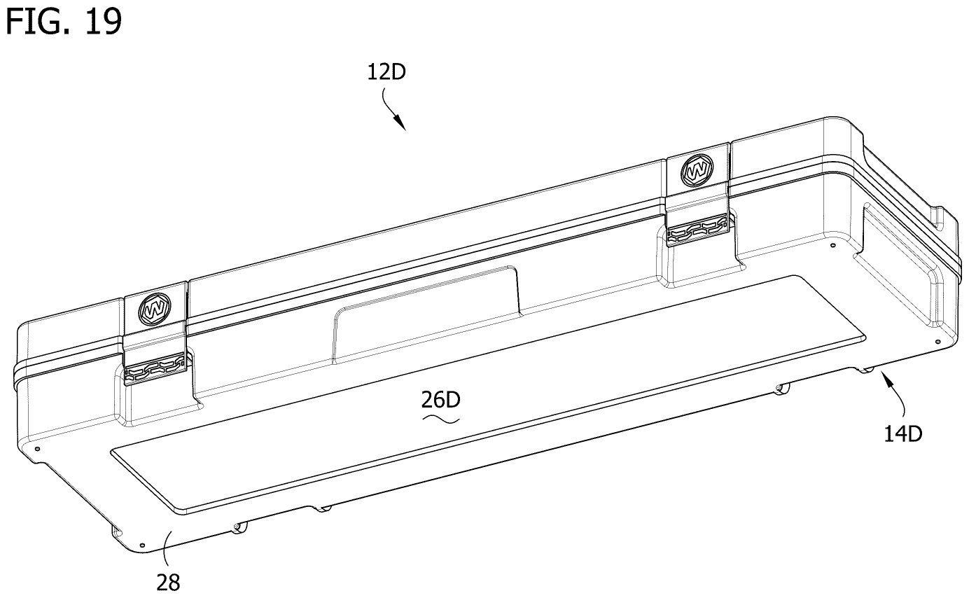

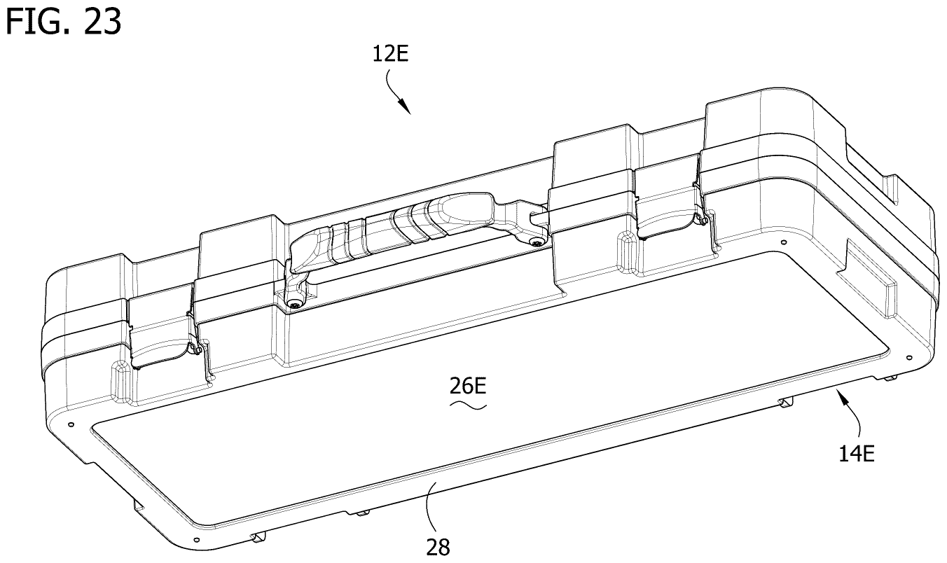

Referring to FIGS. 2-24, each container 12A-E includes a base 14A-E and a lid 16A-E. Each container 12A-E includes an interior or compartment 18 (e.g., storage interior or compartment) sized and shaped to receive the one or more items I. Together, the base 14A-E and the lid 16A-E define the interior 18. When the lid 16A-E is closed, the lid and the base 14A-E enclose the interior 18. The base 14A-E forms the bottom of the container 12A-E and the lid 16A-E forms the top of the container 12A-E. In the illustrated embodiment, the base 14A-E and the lid 16A-E are connected by a hinge or pivot connection. In other embodiments, the hinge connection may be omitted. In one embodiment, the container 12A-E may include an item holder 20 (e.g., tool holder), such as an insert having one or more recesses for receiving and positioning the one or more items in the interior 18. The item holder 20 may comprise a plastic (e.g., molded plastic) insert or a foam insert. The item holder 20 sits in the base 14A-E and generally fills the portion of the interior 18 formed by the base. Each container 12A-E may include clips or latches configured to secure the lid 16A-E in a closed position.

The top of bottom of each container 12A-E each include locating structure (e.g., mating locating structure) for engaging or nesting with the locating structure of other containers. The locating structure works to position the containers 12A-E relative to one another, regardless of the size of the containers. The locating structure is also interchangeably receivable/mateable with the locating structure of the containers 12A-E of its own size and of other sizes. This way, the locating structure is able to position the different sizes of containers 12A-E in a single vertical stack (e.g., position the containers within the same general footprint to form a generally vertical stack). Generally, the locating structure positions the containers 12A-E relative to one another at least one of longitudinally or laterally (desirably, both) such that at least one of the sides (e.g., front side, back side, right side, and/or left side) of the containers are generally vertically aligned. Overall, the containers 12A-E (or a sub-group thereof) may have matching standard dimensions. As used herein, a standard dimension refers to a length or width of the container 12A-E. For example, the length of the medium and small containers 12B, 12C may match (e.g., be the same as) the width of the large container 12A. The locating structure is configured to align the matching standard dimensions of the containers 12A-E when the containers are stacked on top of one another so arrange the containers in a vertical stack.

The locating structure on the top of the container 12A-E comprises one or more mating projections or plateaus 22A-E. The one or more mating projections 22A-E are part of the lid 16A-E and extend upward from an upper surface 24 of the lid. The locating structure on the bottom of the container 12A-E comprises a mating recess 26A-E. The mating recess 26A-E is part of the base 14A-E and extends upward from a bottom surface 28 of the base. The one or more projections 22A-E are received in the recesses 26A-E to position the containers 12A-E relative to one another when one storage container is stacked on another. It will be appreciated that the locations of the projections and recesses can be reversed (e.g., the recesses are on the lid and the projections are on the base) without departing from the scope of the present disclosure. In general, the bottom surface 28 of the base 14A-E is in close proximity to or rests on the upper surface 24 of the lid 16A-E when the containers 12A-E are stacked on one another. In one embodiment, the base 14A-E may include one or more feet or pins that engage the upper surface 24 of the lid 16A-E. In one embodiment, the upper surface 24 of the lid 16A-E may comprises a resiliently compressible material (e.g., rubber, silicone, etc.) and/or may have a textured surface (e.g., plurality of recesses in a designated pattern) which may compress and/or receive the pins such that the bottom surface 28 rests on the upper surface 24.

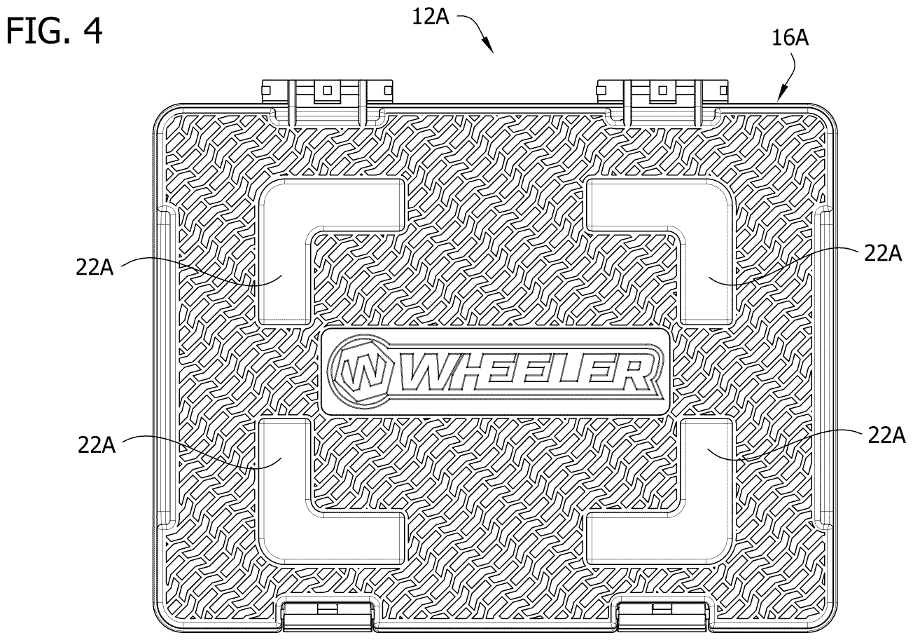

Referring to FIGS. 2-4, the locating structure on the top of the large container 12A comprises a plurality of mating projections 22A (e.g., first mating projections). In the illustrated embodiment, the lid 16A of the large container 12A includes four mating projections 22A, although more or fewer mating projections may be used without departing from the scope of the present disclosure. Each mating projection 22A has an L-shape (in plan) (FIG. 4). The mating projections 22A are spaced apart from one another. The mating projections 22A are arranged to generally define a rectangle. Accordingly, in the illustrated embodiment, the mating projections 22A are arranged in a 2×2 grid. In other words, the locating structure on the top of the large container 12A comprises a four-part segmented rectangular locating structure. The gaps or spaces between the mating protrusions 22A allow the other sizes of containers, such as the small container 12C and the medium container 12B, to be stacked and positioned on the large container 12A. The locating structure on the bottom of the large container 12A comprises a mating recess 26A. In the illustrated embodiment, the bottom of the large container 12A only includes the single mating recess 26A. In other words, the base 14A of the large container 12A is free of additional (e.g., a second, third, fourth, etc.) mating recesses. The single mating recess 26A is sized and shaped to receive all four mating projections 22A on the top of another large container 12A, when two large containers are stacked on top of one another. The mating recess 26A is sized and shaped to correspond to or match the rectangle formed by the four mating projections 22A. Accordingly, the mating recess 26A also has a rectangle shape (in plan). The footprints of the mating recess 26A and the rectangle formed by the mating projections 22A are vertically aligned. The sides or edges of the base 14A defining the mating recess 26A engage with the outer facing sides or edges of the mating projections 22A to laterally and longitudinally position the two large containers 12A relative to one another, such that their footprints (e.g., front sides, rear sides, left sides, and right sides) are vertically aligned. The engagement of the edges of the mating recess 26A and mating projections 22A also inhibits the two large containers 12A from moving longitudinally (e.g. left side-to-right side or in a direction parallel to a length of the large container) and laterally (e.g., front-to-back or in a direction parallel to a width of the large container) relative to one another.

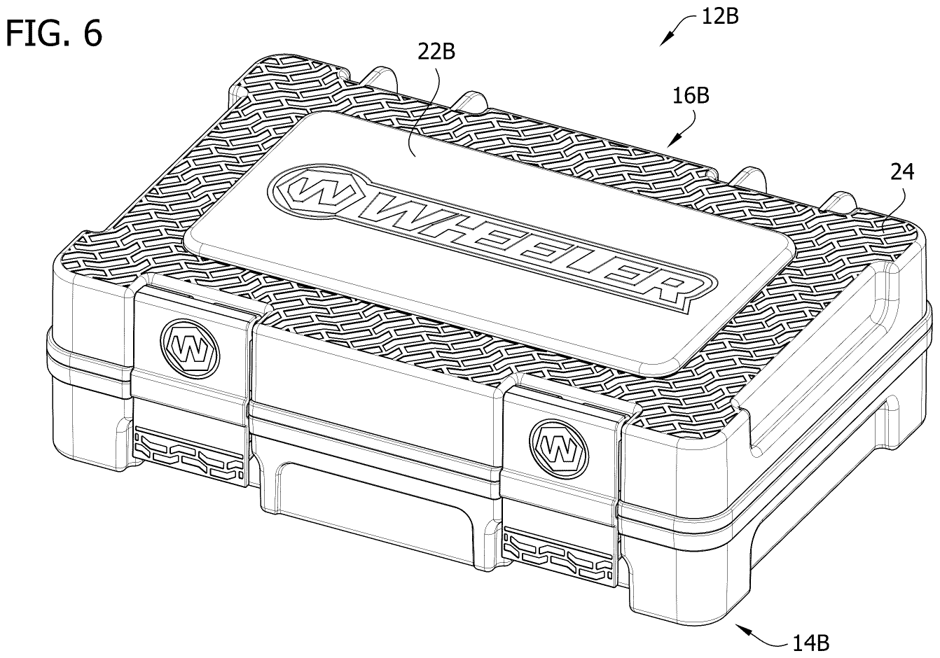

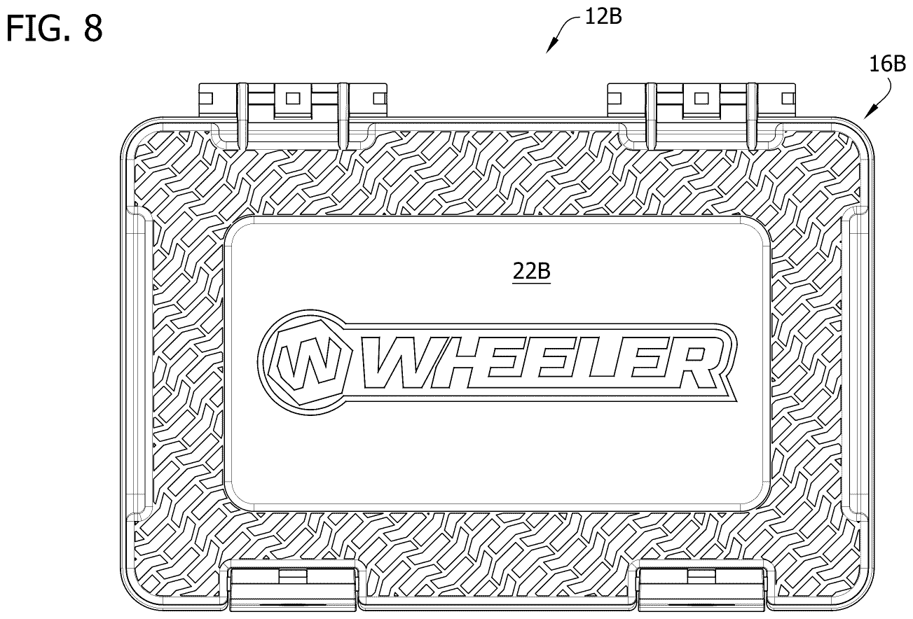

Referring to FIGS. 6-8, the locating structure on the top of the medium container 12B comprises a mating projection 22B (e.g., second mating projection). In the illustrated embodiment, the top of the medium container 12B only includes the single mating projection 22B. In other words, the lid 16B of the medium container 12B is free of additional (e.g., a second, third, fourth, etc.) mating projections. The single mating projection 22B has a rectangular shape (in plan) (FIG. 8). The locating structure on the bottom of the medium container 12B comprises a mating recess 26B. In the illustrated embodiment, the bottom of the medium container 12B only includes the single mating recess 26B. In other words, the base 14B of the medium container 12B is free of additional (e.g., a second, third, fourth, etc.) mating recesses. The single mating recess 26B is sized and shaped to receive the mating projection 22B on the top of another medium container 12B, when two medium containers are stacked on top of one another. The mating recess 26B is sized and shaped to correspond to or match the mating projection 22B. Accordingly, the mating recess 26B also has a rectangle shape (in plan). The footprints of the mating recess 26B and the mating projection 22B are vertically aligned. The sides or edges of the base 14B defining the mating recess 26B engage with the sides or edges of the mating projection 22B to laterally and longitudinally position the two medium containers 12B relative to one another, such that their footprints (e.g., front sides, rear sides, left sides, and right sides) are vertically aligned. The engagement of the edges of the mating recess 26B and mating projection 22B also inhibits the two medium containers 12B from moving longitudinally (e.g. left side-to-right side or in a direction parallel to a length of the medium container) and laterally (e.g., front-to-back or in a direction parallel to a width of the medium container) relative to one another.

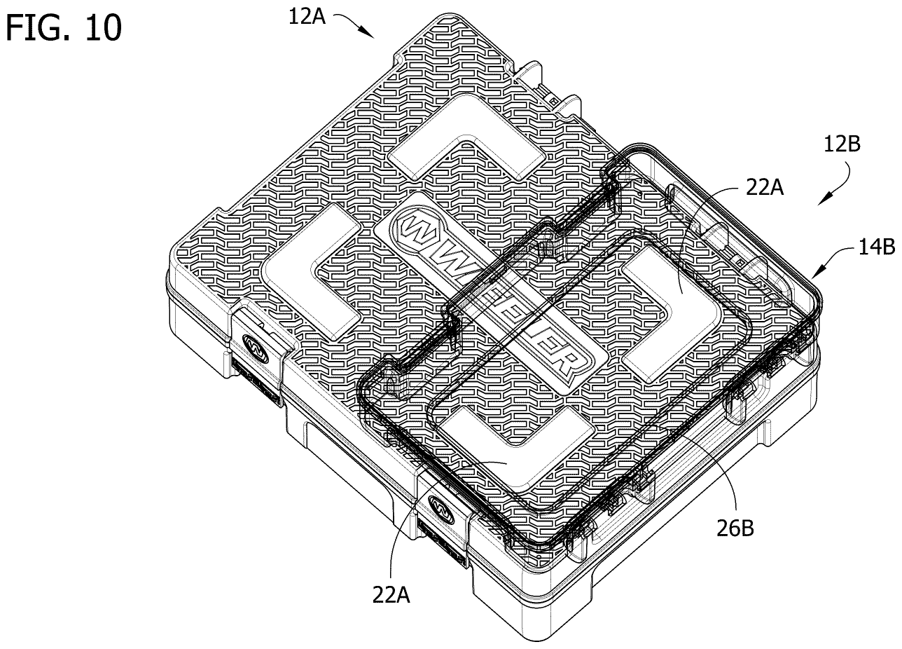

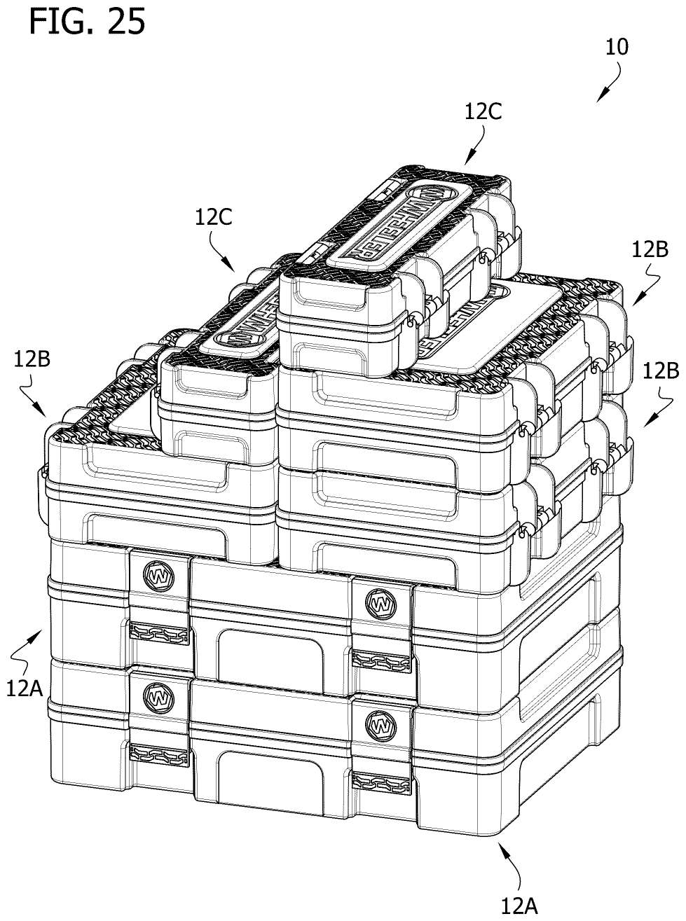

Referring to FIG. 10, the mating recess 26B on the bottom of the medium container 12B receives two of the mating projections 22A on the top of the large container 12A, when the medium container is stacked on top of the large container. Specifically, the mating recess 26B of the medium container 12B receives the left-two mating projections 22A of the large container 12A (if arranged toward the left side of the large container) or the right-two mating projections (as shown in FIG. 10) of the large container (if arranged toward the right side of the large container). When stacked, a foot of the base 14B (which extends around and is formed by the mating recess 26B) extends through two (broadly, at least one) gaps in the mating projections 22A on the top of the large container 12A, thereby permitting the locating structures of the large and medium containers to mate or nest together. The foot of the base 14B forms the bottom surface 28. The mating of the two mating projections 22A with the mating recess 26B positions (e.g., laterally or front-to-back) the medium container 12B relative to the large container 12A. Two of the sides (broadly, at least two of the sides) of the medium container 12B are vertically aligned with two of the sides (broadly, at least two of the sides) of the large container 12A. In the illustrated embodiment, the medium container 12B is oriented or rotated 90-degrees relative to the large container 12A when stacked on the large container. A left side of the medium container 12B is vertically aligned with one of the front or rear side of the large container 12A and the right side of the medium container is vertically aligned with the other of the front or rear side of the large container. In this embodiment, the mating of the mating projections 22A with the mating recess 26B generally only positions the medium container 12B front-to-back relative to the large container 12A. The edges or sides (e.g., left and right edges) of the base 14B defining the mating recess 26B engage with the sides or edges (e.g., front and back edges) of the mating protrusions 22A to position the medium container 12B front-to-back relative to the large container 12A. The engagement of these edges of the mating recess 26B and mating projections 22A also inhibits the medium container 12B from moving laterally (e.g., front-to-back or in a direction parallel to a width of the large container) relative to the large container 12A. Thus, broadly, the two mating projections 22A received by the mating recess 26B inhibit the medium container 12B from moving forward and rearward relative to the large container 12A. As illustrated, the mating recess 26B of the medium container 12B permits the medium container to be moved longitudinally (e.g. left side-to-right side or in a direction parallel to a length of the large container) such that the front or rear side of the medium container can be vertically aligned with one of the left or right side of the large container. In other words, the two mating projections 22A received by the mating recess 26B permit some left side-to-right side movement of the medium container 12B relative to the large container 12A. In the illustrated embodiment, the length of the medium container 12B match the width of the large container 12A, and the width of the medium container 12B is about half the length of the large container. This allows two medium containers 12B to be stacked side-by-side on top of a large container 12A. When stacked, the medium container 12B is substantially (more specifically, entirely) within the footprint of the large storage container 12A. If two medium containers 12B are stacked, both medium containers are substantially within the footprint of the large container 12A (with all sides vertically aligned), with only the hinges overhanging the large container (see FIG. 25).

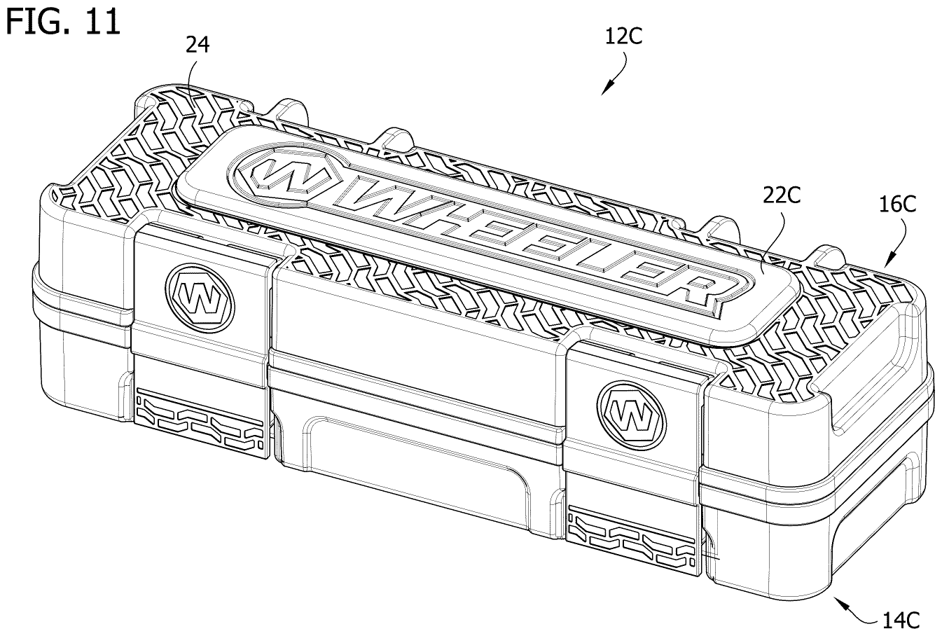

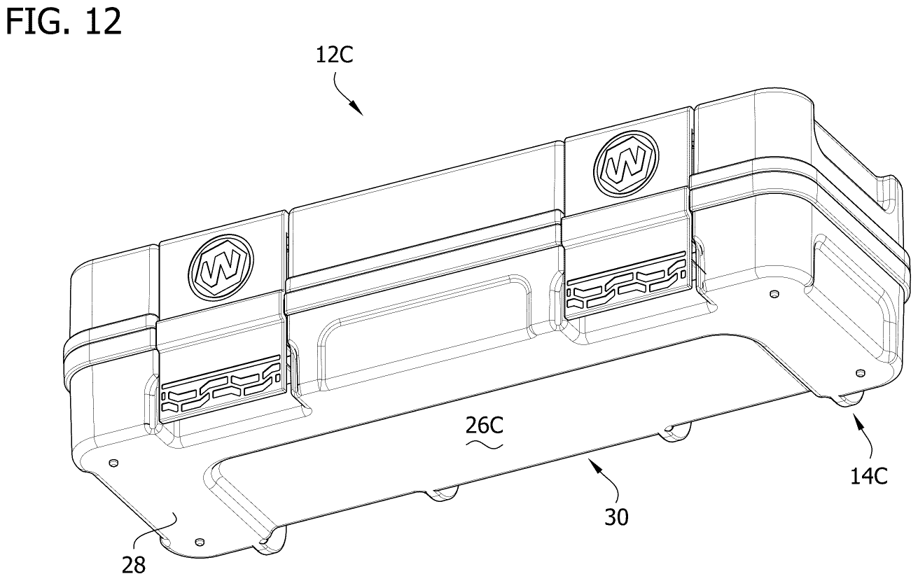

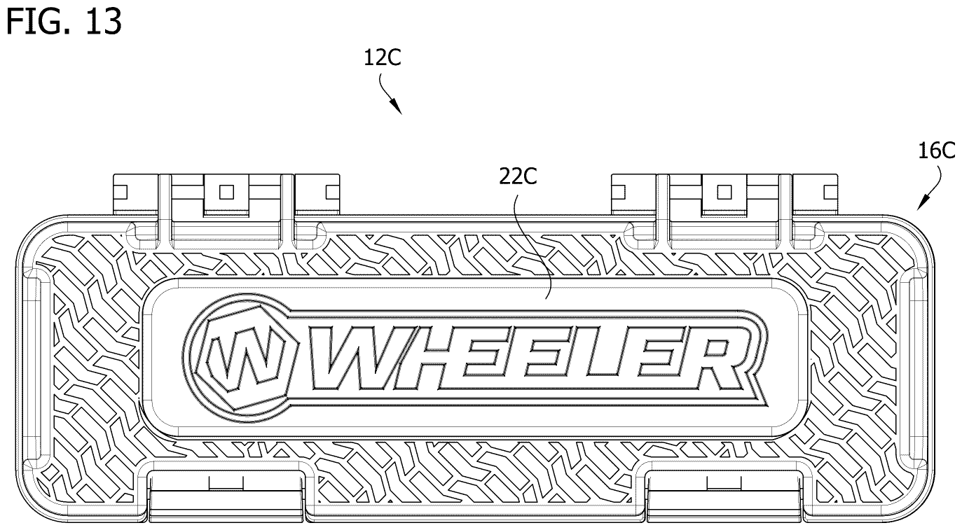

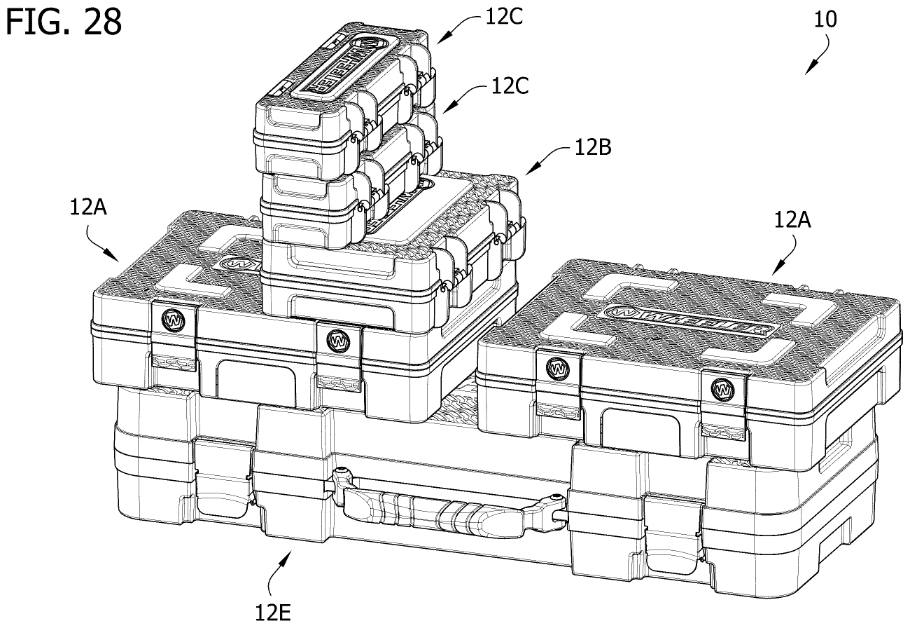

Referring to FIGS. 11-13, the locating structure on the top of the small container 12C comprises a mating projection 22C (e.g., third mating projection). In the illustrated embodiment, the top of the small container 12C only includes the single mating projection 22C. In other words, the lid 16C of the small container 12C is free of additional (e.g., a second, third, fourth, etc.) mating projections. The single mating projection 22C has a rectangular shape (in plan) (FIG. 13). The locating structure on the bottom of the small container 12C comprises a mating recess 26C. In the illustrated embodiment, the bottom of the small container 12C only includes the single mating recess 26C. In other words, the base 14C of the small container 12C is free of additional (e.g., a second, third, fourth, etc.) mating recesses. The single mating recess 26C is sized and shaped to receive the mating projection 22C on the top of another small container 12C, when two small containers are stacked on top of one another. The mating recess 26C is sized and shaped to correspond to or match the mating projection 22C. Accordingly, the mating recess 26C also has a rectangle shape (in plan). The footprints of the mating recess 26C and the mating projection 22C are offset front-to-back (specially, mating projection is offset forward of the mating recess). The mating recess 26C include an open front side and/or rear side 30 (FIG. 12). The open side 30 allows the mating recess 26C to mate with the mating projections 22A, 22B, 22D, 22E of other containers 12A, 12B, 12D, 12E. The left and right sides or edges of the base 14C defining the mating recess 26C engage with the left and right sides or edges of the mating projection 22C to longitudinally position the two small containers 12C relative to one another, such that their left and rights sides are vertically aligned. Further, the mating recess 26C is larger (e.g., footprint or area thereof) than the mating projection 22C and allows some movement front-to-back of the two small containers 12C relative to one another. However, because of the mating recess 26C and mating projection 22C are vertically offset (front-to-back) from one another, the footprints (e.g., front sides and rear sides) of the two small containers cannot be vertically aligned when stacked (see FIG. 28). In another embodiment, the mating recess and projection 26C, 22C can be vertically aligned such that the footprints of two stacked small containers can be aligned. The engagement of the left and right edges of the mating recess 26C and mating projection 22C also inhibits the two small containers 12C from moving longitudinally (e.g. left side-to-right side or in a direction parallel to a length of the small container) relative to one another. Further, if present, the closed front or rear side (opposite the open side 30) of the mating recess 26C can inhibit the two small containers 12C from moving laterally (e.g., front-to-back or in a direction parallel to a width of the small container) in one lateral direction relative to one another.

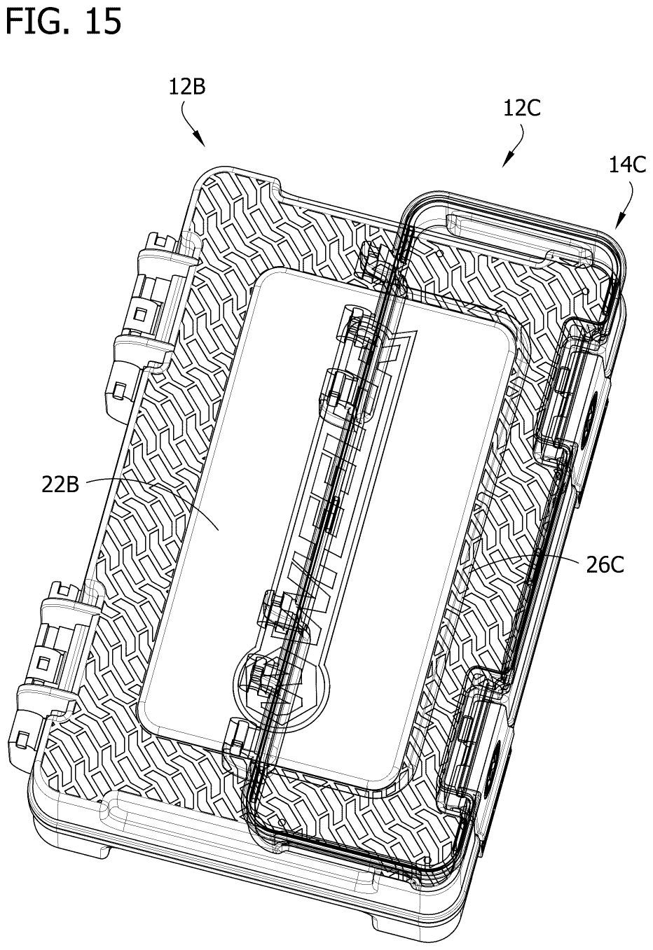

Referring to FIG. 15, the mating recess 26C on the bottom of the small container 12C receives the mating projection 22B on the top of the medium container 12B, when the small container is stacked on top of the medium container. Specifically, the mating recess 26C of the small container 12C receives a front half or portion of the mating projection 22B of the medium container 12B (if arranged toward the front side of the medium container) (as shown in FIG. 15) or a rear half or portion of the mating projection of the medium container (if arranged toward the rear side of the large container). When stacked, the mating projection 22B of the medium container 12B extends out of the mating recess 26C of the small container 12C via the open side 30. This permit the locating structure of the small and medium containers 12B, 12C to mate or nest together. The mating of the mating projection 22B with the mating recess 26C positions (e.g., longitudinally or left side-to-right side) the small container 12C relative to the medium container 12B. Two of the sides (broadly, at least two of the sides) of the small container 12C are vertically aligned with two of the sides (broadly, at least two of the sides) of the medium container 12B. In the illustrated embodiment, the length of the small container 12C is parallel to the length of the medium container 12B when stacked on the medium container. A left side of the small container 12C is vertically aligned with one of the left or right side of the medium container 12B and the right side of the small container is vertically aligned with the other of the left or right side of the medium container. In this embodiment, the mating of the mating projection 22B with the mating recess 26C positions the small container 12C longitudinally (e.g. left side-to-right side) relative to the medium container 12B. The edges or sides (e.g., left and right edges) of the base 14C defining the mating recess 26C engage with the sides or edges (e.g., left and right edges) of the mating protrusion 22B to position the small container 12C longitudinally relative to the medium container 12B. The engagement of these edges of the mating recess 26C and mating projection 22B also inhibits the small container 12C from moving longitudinally relative to the medium container 12B. Thus, broadly, the mating projection 22B received by the mating recess 26C inhibits the small container 12C from moving left side-to-right side relative to the medium container 12B.

The mating of the mating projection 22B with the mating recess 26C also positions the small container 12C laterally (e.g. front-to-back) relative to the medium container 12B. The closed edge or side (e.g., front or rear edge) of the base 14C defining the mating recess 26C opposite the open side 30 engages with the front or rear side or edge of the mating protrusion 22B to position the small container 12C laterally relative to the medium container 12B. This vertically aligns the front side of the small container 12C with the front side or rear side of the medium container 12B. The engagement of these edges of the mating recess 26C and mating projection 22B also inhibits the small container 12C from moving longitudinally (in one direction either forward or rearward depending on where the small container is placed on the medium container) relative to the medium container 12B. Thus, broadly, the mating projection 22B received by the mating recess 26C inhibits the small container 12C from moving either forward or rearward relative to the medium container 12B (and allows movement in the other of the forward or rearward, depending on placement). When stacked, the small container 12C is entirely (broadly, substantially) within the footprint of the medium storage container 12A. In the illustrated embodiment, the length of the small container 12C match the length of the medium container 12B (and the width of the large container 12A), and the width of the small container is about half the width of the medium container (and about a quarter the length of the large container). This allows two small containers 12C to be stacked side-by-side on top of a medium container 12B. In this arrangement, the open sides 30 of the two small containers 12C are adjacent to each other. In the illustrated embodiment, the open side 30 is an open rear side. In other embodiments, the open side may be an open front side. This may be desirable as it allows the front sides of two small containers 12C to face (e.g., engage) each other when stacked side-by-side on top of a medium container 12C, instead of the rear sides as a hinges on the rear side of the small container may prevent the two small containers from fitting neatly on the medium container (e.g., one or both of the small containers may overhang or be offset from the front and/or rear side of the medium container).

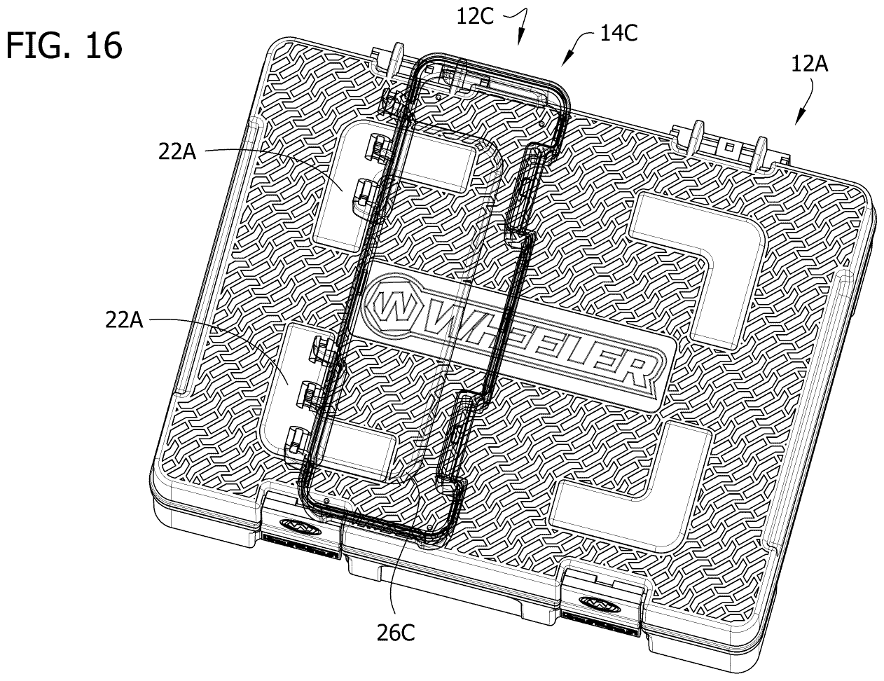

Referring to FIG. 16, the mating recess 26C on the bottom of the small container 12C receives two of the mating projections 22A on the top of the large container 12A, when the small container is stacked on top of the large container. Specifically, the mating recess 26C of the small container 12C receives the left-two mating projections 22A (as shown in FIG. 16) of the large container 12A (if arranged toward the left side of the large container) or the right-two mating projections of the large container (if arranged toward the right side of the large container). When stacked, the two mating projections 22A of the large container 12A extend out of the mating recess 26C of the small container 12C via the open side 30. When stacked toward the center of the large container as shown, a foot of the base 14C (which extends around and is formed by the mating recess 26C) extends through two (broadly, at least one) gaps in the mating projections 22A on the top of the large container 12A, thereby permitting the locating structures of the large and small containers to mate or nest together. The foot of the base 14C forms the bottom surface 28. The mating of the two mating projections 22A with the mating recess 26C positions (e.g., laterally or front-to-back) the small container 12C relative to the large container 12A. Two of the sides (broadly, at least two of the sides) of the small container 12C are vertically aligned with two of the sides (broadly, at least two of the sides) of the large container 12A. In the illustrated embodiment, the small container 12C is oriented or rotated 90-degrees relative to the large container 12A when stacked on the large container. A left side of the small container 12C is vertically aligned with one of the front or rear side of the large container 12A and the right side of the small container is vertically aligned with the other of the front or rear side of the large container. In this embodiment, the mating of the mating projections 22A with the mating recess 26C generally only positions the small container 12C front-to-back relative to the large container 12A. The edges or sides (e.g., left and right edges) of the base 14C defining the mating recess 26C engage with the sides or edges (e.g., front and back edges) of the mating protrusions 22A to position the small container 12C front-to-back relative to the large container 12A. The engagement of these edges of the mating recess 26C and mating projections 22A also inhibits the small container 12C from moving laterally (e.g., front-to-back or in a direction parallel to a width of the large container) relative to the large container 12A. Thus, broadly, the two mating projections 22A received by the mating recess 26C inhibit the medium container 12B from moving forward and rearward relative to the large container 12A. As illustrated, the mating recess 26C of the small container 12C permits the small container to be moved longitudinally (e.g. left side-to-right side or in a direction parallel to a length of the large container) such that the front side of the small container can be vertically aligned with one of the left or right side of the large container when placed on the far left or right, respectively, of the large container. This longitudinal movement also permits the small container to be positioned to allow other sizes of containers (e.g., medium container 12B) to be stacked on the large container and mate with the mating projections 22A unused by the small container. In other words, the two mating projections 22A received by the mating recess 26C permit some left side-to-right side movement of the small container 12C relative to the large container 12A. When stacked, the small container 12C is entirely (broadly, substantially) within the footprint of the large storage container 12A. It will be appreciated that four small containers 12C (arranged in a row) could be nested on top of the large container 12A, including two pairs of small containers having their open sides 30 face each other to accommodate the locating structure on top of the large container.

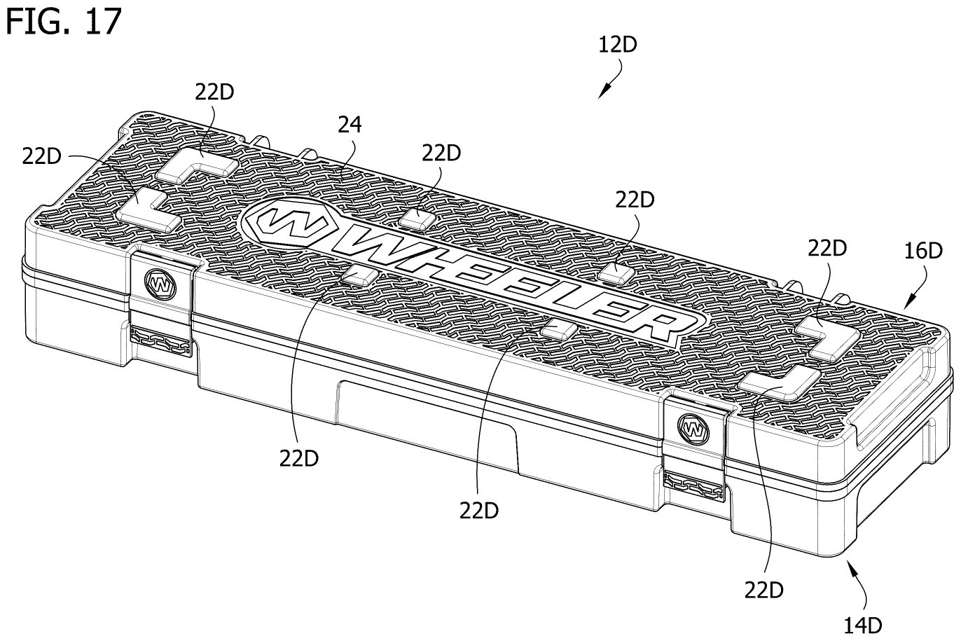

Referring to FIGS. 17-19, the locating structure of the jumbo medium container 12D is similar to the locating structure of the large container 12C. The locating structure on the top of the jumbo medium container 12D comprises a plurality of mating projections 22D (e.g., fourth mating projections). In the illustrated embodiment, the lid 16D of the jumbo medium container 12D includes eight mating projections 22D, although more or fewer mating projections may be used without departing from the scope of the present disclosure. The mating projections 22D are spaced apart from one another. The mating projections 22D are arranged to generally define a rectangle. Accordingly, in the illustrated embodiment, the mating projections 22D are arranged in a 2×4 grid. In other words, the locating structure on the top of the jumbo medium container 12D comprises an eight-part segmented rectangular locating structure. In the illustrated embodiment, the mating projections 22D at the corners of the rectangle have an L-shape (in plan) and the other mating projections have a square shape (in plan). The gaps or spaces between the mating protrusions 22D allow the other sizes of containers, such as the small container 12C and the medium container 12B, to be stacked and positioned on the jumbo medium container 12D. The locating structure on the bottom of the jumbo medium container 12D comprises a mating recess 26D. In the illustrated embodiment, the bottom of the jumbo medium container 12D only includes the single mating recess 26D. In other words, the base 14D of the jumbo medium container 12D is free of additional (e.g., a second, third, fourth, etc.) mating recesses. The single mating recess 26D is sized and shaped to receive all eight mating projections 22D on the top of another jumbo medium container 12D, when two jumbo medium containers are stacked on top of one another. The mating recess 26D is sized and shaped to correspond to or match the rectangle formed by the eight mating projections 22D. Accordingly, the mating recess 26D also has a rectangle shape (in plan). The footprints of the mating recess 26D and the rectangle formed by the mating projections 22D are vertically aligned. The sides or edges of the base 14D defining the mating recess 26D engage with the outer facing sides or edges of the mating projections 22D to laterally and longitudinally position the two jumbo medium containers 12D relative to one another, such that their footprints (e.g., front sides, rear sides, left sides, and right sides) are vertically aligned. The engagement of the edges of the mating recess 26D and mating projections 22D also inhibits the two jumbo medium containers 12D from moving longitudinally (e.g. left side-to-right side or in a direction parallel to a length of the jumbo medium container) and laterally (e.g., front-to-back or in a direction parallel to a width of the jumbo medium container) relative to one another. The jumbo medium container 12D and the large container 12A do not mate or nest with one another.

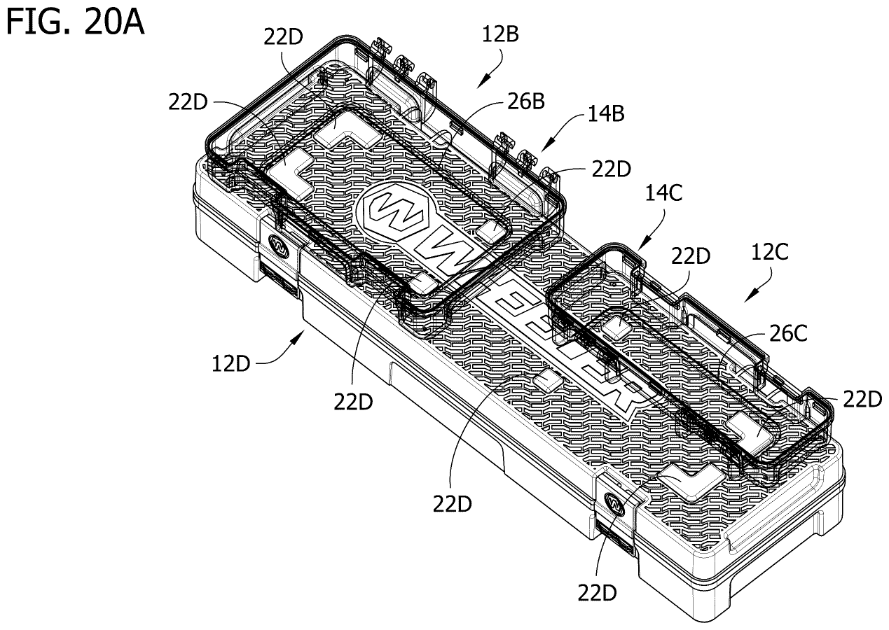

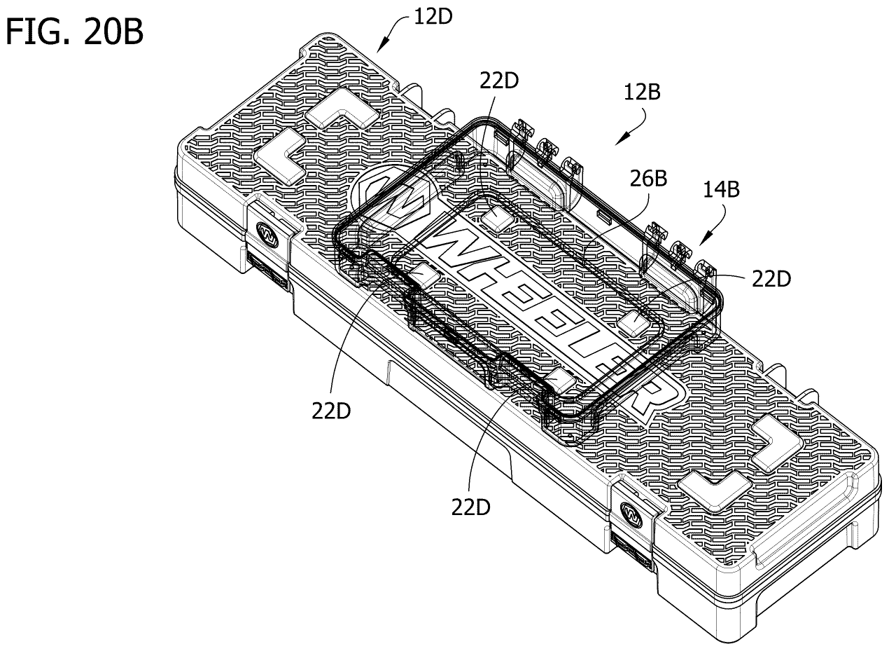

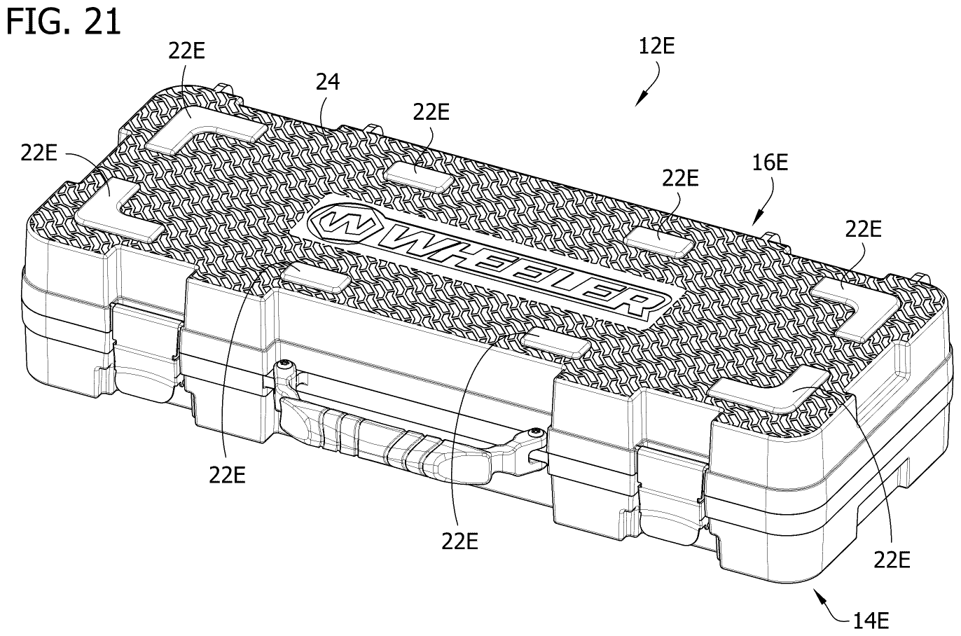

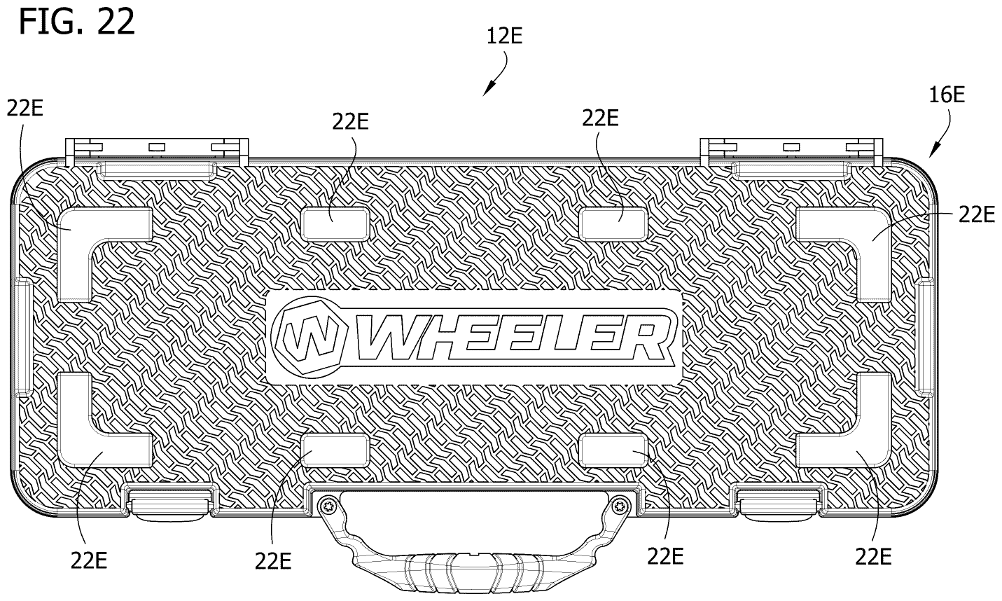

Referring to FIGS. 20A-B, the medium container 12B mates with the jumbo medium container 12D in much the same way as the medium container mates with the large container 12A. Accordingly, unless clearly stated or indicated otherwise, the above descriptions regarding the mating of the medium container 12B with the large container 12A also apply to the mating of the medium container with the jumbo medium container 12D. The medium container 12B can be mounted at three different positions (e.g., left, middle, right) on the jumbo medium container 12D. In each position, the mating recess 26B on the bottom of the medium container 12B receives four of the mating projections 22D on the top of the jumbo medium container 12D, when the medium container is stacked on top of the jumbo medium container. The mating of the four mating projections 22D with the mating recess 26B positions (e.g., laterally or front-to-back) the medium container 12B relative to the jumbo medium container 12D, such that the front sides and the rear sides of the two containers are vertically aligned (but not the left sides when in the left position or the right sides when in the right position). In the illustrated embodiment, the length of the medium container 12B is parallel to the length of the jumbo medium container 12D when stacked on the jumbo medium container. In this embodiment, the mating of the mating projections 22D with the mating recess 26B positions the medium container 12B longitudinally and laterally relative to the jumbo medium container 12D. The edges or sides of the base 14B defining the mating recess 26B engage with the sides or edges of the mating protrusions 22D to position and inhibit longitudinal and lateral movement of the medium container 12B relative to the jumbo medium container 12D (in one embodiment, the length of the middle four mating projections 22D are increased (similar to what is shown for the mating projections 22E in FIGS. 21 and 22) to also inhibit the medium container from moving when in the middle position). In the illustrated embodiment, the width of the medium container 12B match the width of the jumbo medium container 12D, and the width of the medium container 12B is less than half the length of the jumbo medium container. This allows two medium containers 12B to be stacked side-by-side on top of a jumbo medium container 12D. When stacked, the medium container 12B is substantially (more specially, entirely) within the footprint of the jumbo medium container 12D. If two medium containers 12B are stacked, both medium containers are entirely within the footprint of the jumbo medium container 12D. Further, if two medium containers 12B are stacked on one jumbo medium container 12D, a second jumbo medium container may then be stacked on (and nest with) the medium containers.

Referring to FIG. 20A, the small container 12C mates with the jumbo medium container 12D in much the same way as the small container mates with the large container 12A. Accordingly, unless clearly stated or indicated otherwise, the above descriptions regarding the mating of the small container 12C with the large container 12A also apply to the mating of the small container with the jumbo medium container 12D. The small container 12C can be mounted at six different positions (e.g., left-front, left-back, middle-front, middle-back, right-front, and right-back) on the jumbo medium container 12D. In each position, the mating recess 26C on the bottom of the small container 12C receives two of the mating projections 22D on the top of the jumbo medium container 12D, when the small container is stacked on top of the jumbo medium container. None, one, or both of the mating projections 22D may extend out of the mating recess 26C of the small container 12C via the open side 30. The mating of the two mating projections 22D with the mating recess 26C positions (e.g., longitudinally or left side-to-right side) the small container 12C relative to the jumbo medium container 12D (but does not vertical align the left sides when in the left positions or the right sides when in the right positions). In the illustrated embodiment, the length of the small container 12C is parallel to the length of the jumbo medium container 12D when stacked on the jumbo medium container. In this embodiment, the mating of the mating projections 22D with the mating recess 26C generally only positions the small container 12C longitudinally relative to the jumbo medium container 12D. The edges or sides (e.g., left and right edges) of the base 14C defining the mating recess 26C engage with the sides or edges (e.g., left and right edges) of the two mating protrusions 22D to position and inhibit longitudinal movement of the small container 12C relative to the jumbo medium container 12D. As illustrated, the mating recess 26C of the small container 12C permits the small container to be moved laterally such that the front or rear side of the small container can be vertically aligned with one of the front or rear side of the jumbo medium container when placed on the jumbo medium container. When stacked, the small container 12C is entirely (broadly, substantially) within the footprint of the jumbo medium storage container 12D.

Referring to FIGS. 21-23, the locating structure of the extra-large container 12E is similar to the locating structure of the large container 12C. The locating structure on the top of the extra-large container 12E comprises a plurality of mating projections 22E (e.g., fifth mating projections). In the illustrated embodiment, the lid 16E of the extra-large container 12E includes eight mating projections 22E, although more or fewer mating projections may be used without departing from the scope of the present disclosure. The mating projections 22E are spaced apart from one another. The mating projections 22E are arranged to generally define a rectangle. Accordingly, in the illustrated embodiment, the mating projections 22E are arranged in a 2×4 grid. In other words, the locating structure on the top of the extra-large container 12E comprises an eight-part segmented rectangular locating structure. In the illustrated embodiment, the mating projections 22E at the corners of the rectangle have an L-shape (in plan) and the other mating projections have a rectangle shape (in plan). The gaps or spaces between the mating protrusions 22E allow the other sizes of containers, such as the small container 12C, the medium container 12B, and the large container 12A, to be stacked and positioned on the extra-large container 12E. The locating structure on the bottom of the extra-large container 12E comprises a mating recess 26E. In the illustrated embodiment, the bottom of the extra-large container 12E only includes the single mating recess 26E. In other words, the base 14E of the extra-large container 12E is free of additional (e.g., a second, third, fourth, etc.) mating recesses. The single mating recess 26E is sized and shaped to receive all eight mating projections 22E on the top of another extra-large container 12E, when two extra-large containers are stacked on top of one another. The mating recess 26E is sized and shaped to correspond to or match the rectangle formed by the eight mating projections 22E. Accordingly, the mating recess 26E also has a rectangle shape (in plan). The footprints of the mating recess 26E and the rectangle formed by the mating projections 22E are vertically aligned. The sides or edges of the base 14E defining the mating recess 26E engage with the outer facing sides or edges of the mating projections 22E to laterally and longitudinally position the two extra-large containers 12E relative to one another, such that their footprints (e.g., front sides, rear sides, left sides, and right sides) are vertically aligned. The engagement of the edges of the mating recess 26E and mating projections 22E also inhibits the two extra-large containers 12E from moving longitudinally (e.g. left side-to-right side or in a direction parallel to a length of the extra-large container) and laterally (e.g., front-to-back or in a direction parallel to a width of the extra-large container) relative to one another. The jumbo medium container 12D and the extra-large container 12E do not mate or nest with one another.

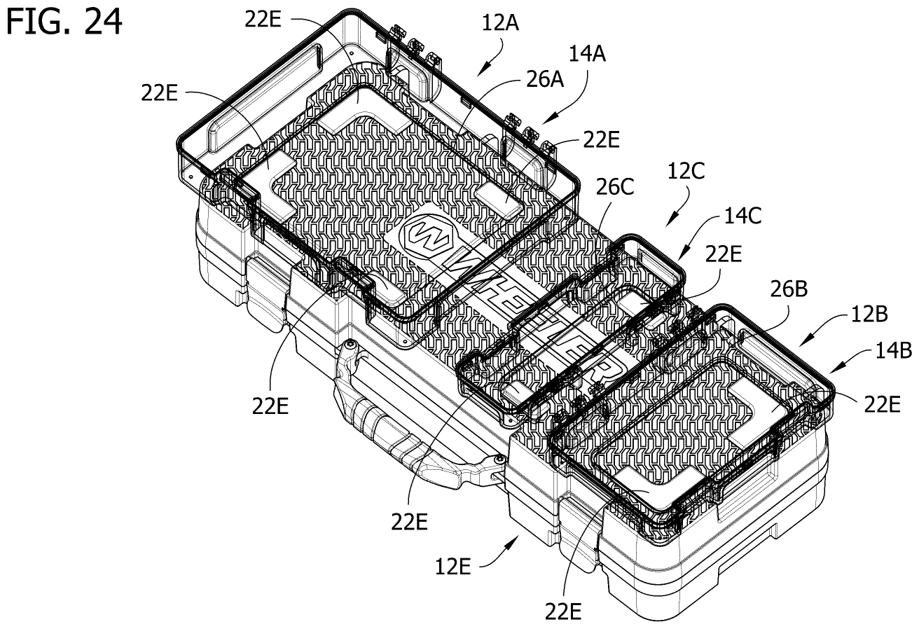

Referring to FIG. 24, the large container 12A mates with the extra-large container 12E in much the same way as two large containers mate with one another. Accordingly, unless clearly stated or indicated otherwise, the above descriptions regarding the mating of two large containers 12A also applies to the mating of the large container with the extra-large container 12E. The large container 12A can be mounted at three different positions (e.g., left, middle, right) on the extra-large container 12E. In each position, the mating recess 26A on the bottom of the large container 12A receives four of the mating projections 22E on the top of the extra-large container 12E, when the large container is stacked on top of the extra-large container. The mating of the four mating projections 22E with the mating recess 26A positions (e.g., laterally or front-to-back) the large container 12A relative to the extra-large container 12E, such that the front sides and the rear sides of the two containers are vertically aligned (but not the left sides when in the left position or the right sides when in the right position). When stacked in the left or right position, the large container 12A may slightly overhang the left or right side of the extra-large container 12E (broadly, still be positioned substantially within the footprint of the extra-large container). In the illustrated embodiment, the length of the large container 12A is parallel to the length of the extra-large container 12E when stacked on the extra-large container. In the illustrated embodiment, two large containers 12A can be stacked side-by-side on top of an extra-large container 12E. If two large containers 12A are stacked on one extra-large container 12E, a second extra-large container may then be stacked on (and nest with) the large containers.

Still referring to FIG. 24, the medium container 12B mates with the extra-large container 12E in much the same way as the medium container mates with the large container 12A. Accordingly, unless clearly stated or indicated otherwise, the above descriptions regarding the mating of the medium container 12B with the large container 12A also apply to the mating of the medium container with the extra-large container 12E. The medium container 12B can be mounted at four different positions (e.g., left, middle-left, middle-right, right) on the extra-large container 12E. In each position, the mating recess 26B on the bottom of the medium container 12B receives two of the mating projections 22E on the top of the extra-large container 12E, when the medium container is stacked on top of the extra-large container. Similar to the stacking on the large container 12A, the mating of the two mating projections 22E with the mating recess 26B positions the medium container 12B front-to-back relative to the extra-large container 12E, while allowing left side-to-right side movement of the medium container relative to the extra-large container 12E. This movement allows the front or rear side of the medium container 12B to be vertically aligned with one of the left or right side of the extra-large container 12E when in the respective left or right positions. When stacked, the medium container 12B is substantially (more specifically, entirely) within the footprint of the extra-large container 12E.

Still referring to FIG. 24, the small container 12C mates with the extra-large container 12E in much the same way as the small container mates with the large container 12A. Accordingly, unless clearly stated or indicated otherwise, the above descriptions regarding the mating of the small container 12C with the large container 12A also apply to the mating of the small container with the extra-large container 12E. The small container 12C can be mounted at four different positions (e.g., left, middle-left, middle-right, and right) on the extra-large container 12E. In each position, the mating recess 26C on the bottom of the small container 12C receives two of the mating projections 22E on the top of the extra-large container 12E, when the small container is stacked on top of the jumbo medium container. None or both of the mating projections 22E may extend out of the mating recess 26C of the small container 12C via the open side 30. Similar to the stacking on the large container 12A, the mating of the two mating projections 22E with the mating recess 26C positions the small container 12C front-to-back relative to the extra-large container 12E, while allowing left side-to-right side movement of the small container relative to the extra-large container 12E. This movement allows the front or rear side of the small container 12C to be vertically aligned with one of the left or right side of the extra-large container 12E when in the respective left or right positions. When stacked, the small container 12C is entirely (broadly, substantially) within the footprint of the extra-large storage container 12E.

Using the principles (e.g., the ways the locking structure of each container 12A-E mates with one another) of the present disclosure, the containers of the present disclosure can be arranged in in a variety of different stacked arrangements, some of which will now be described. It is understood that other stacked arrangements are possible and that stacked arrangements do not need to include all sizes of containers 12A-E. The locking structure of the present disclosure is configured such that when stacking the containers 12A-E, the containers in the stack are all positioned such that the containers are all have at least two sides vertically aligned. The containers 12A-E have sides (e.g., front and rear or left and right) that are vertically aligned with the sides (e.g., front and rear or left and right) of the largest size container in the stack. Typically, this alignment will be with the front and rear sides of the largest size container 12A-E in the stack. In other words, the locking structure is configured such that the matching standard dimensions of the different containers are all parallel to and vertically aligned with one another in the stack. In addition, the locking structure of the present disclosure is configured such that the stacked is formed with the largest containers 12A-E on the bottom up to the smallest containers on top. This promotes stability in the stack by positioning the largest (and likely heaviest) containers on the bottom and the smallest (and likely lightest) containers on the top. In particular, the locking structure of the small, medium, and large containers 12C, 12B, 12A are configured such that the stack must be formed with the large containers on the bottom, then the medium containers and then the small containers. For example, due to the mating protrusions 22B of the medium containers 12B extending longitudinally outboard of the mating protrusions 22A of the large container (see FIG. 10 and recall that the mating protrusion 22B is vertically aligned with the mating recess 26B) when the two medium containers are stacked on the large container, another large container cannot mate with the two medium containers when stacked on the two medium containers. Similarly, in another example, due to the forward offset of the mating protrusion 22C of the small container 12C relative to the mating recess 26C of the small container, the mating protrusions 22C of two small containers also extend longitudinal outboard of the mating protrusion 22B of the medium container 12B (see FIG. 15 and recall that the mating protrusion 22C is offset forward of the mating recess 26C) when two small containers are stacked on a medium container. As a result, another medium container 12B cannot mate with the two small containers 12C that are stacked on the medium container.

Referring to FIG. 1, one (e.g., a first) stacked arrangement is generally shown. In this example, the container system 10 includes one large container 12A, two medium containers 12B, and one small containers 12C. The large container 12A forms the base of the stack. The two medium containers 12B are stacked side-by-side (front sides facing each other) on the large container 12A. The small container 12C is stacked on the left medium container 12B (forward portion thereof). As illustrated, all the containers 12A, 12B, 12C in this stack are disposed substantially within the footprint of the large storage container 12A. The left and right sides of the small and medium containers 12C, 12B are all vertically aligned with the respective front and rear sides of the large container 12A.

Referring to FIG. 25, another (e.g., a second) stacked arrangement is generally shown. In this example, the container system 10 includes two large containers 12A, three medium containers 12B, and two small containers 12C. A first large container 12A forms the base of the stack and the second large container is stacked on the first large container. The two medium containers 12B are stacked side-by-side (front sides facing each other) on the second large container 12A. A first small container 12C is stacked on forward portion of the left medium container 12B (in the third level). The third medium container 12B is stacked on the right medium container 12B (in the third level). The second small container 12C is stacked on the forward portion of the third medium container 12B (the medium container in the fourth level). As illustrated, all the containers 12A, 12B, 12C in this stack are disposed substantially within the footprint of the large storage containers 12A. The left and right sides of the small and medium containers 12C, 12B are all vertically aligned with the respective front and rear sides of the large containers 12A.

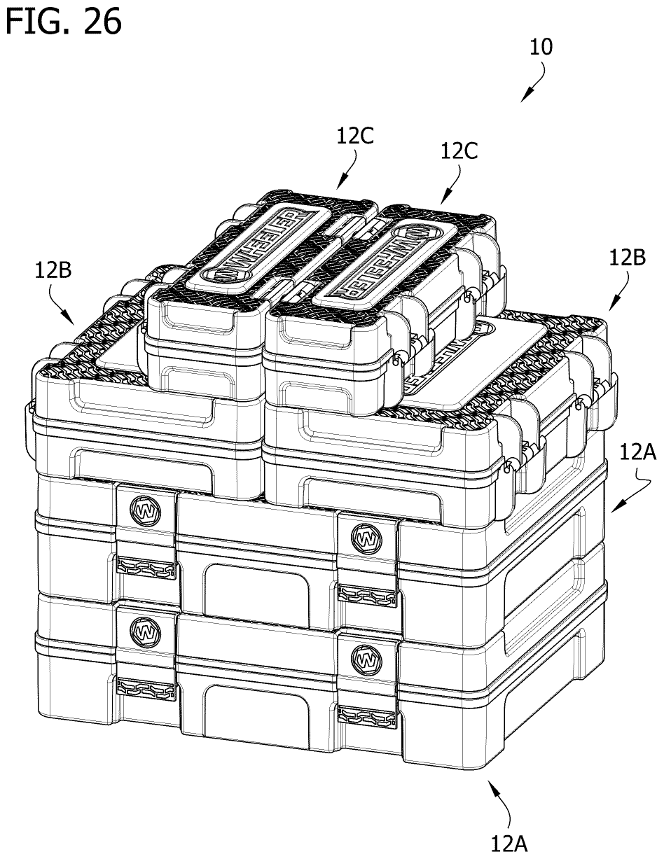

Referring to FIG. 26, another (e.g., a third) stacked arrangement is generally shown. In this example, the container system 10 includes two large containers 12A, two medium containers 12B, and two small containers 12C. A first large container 12A forms the base of the stack and the second large container is stacked on the first large container. The two medium containers 12B are stacked side-by-side (front sides facing each other) on the second large container 12A. The first small container 12C is stacked on the forward portion of the left medium container 12B and the second small container is stacked on the forward portion of the right medium container. As illustrated, all the containers 12A, 12B, 12C in this stack are disposed substantially within the footprint of the large storage containers 12A. The left and right sides of the small and medium containers 12C, 12B are all vertically aligned with the respective front and rear sides of the large containers 12A.

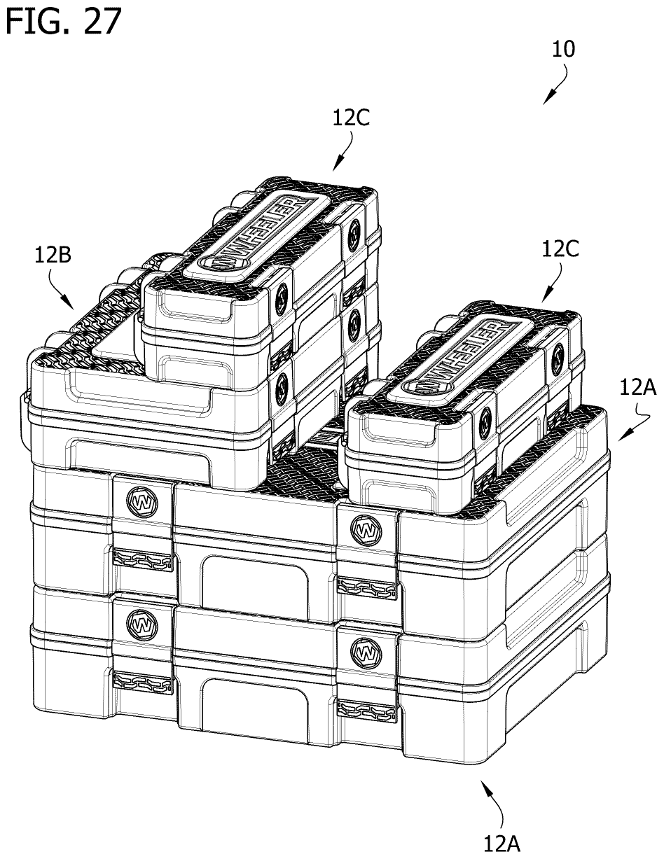

Referring to FIG. 27, another (e.g., a fourth) stacked arrangement is generally shown. In this example, the container system 10 includes two large containers 12A, one medium container 12B, and two small containers 12C. A first large container 12A forms the base of the stack and the second large container is stacked on the first large container. The medium container 12B is stacked on the left portion of the second large container 12A. The first small container 12C is stacked on the right portion of the second large container 12A. The second small container 12C is stacked on the forward portion of the medium container 12B. As illustrated, all the containers 12A, 12B, 12C in this stack are disposed substantially within the footprint of the large storage containers 12A. The left and right sides of the small and medium containers 12C, 12B are all vertically aligned with the respective front and rear sides of the large containers 12A.

Referring to FIG. 28, another (e.g., a fifth) stacked arrangement is generally shown. In this example, the container system 10 includes one extra-large container 12E, two large containers 12A, one medium container 12B, and two small containers 12C. The extra-large container 12E forms the base of the stack. The two large containers 12A are stacked side-by-side (left side facing the right side) on the extra-large container 12E. The medium container 12B is stacked on the right portion of the left large container 12A. The first small container 12C is stacked on the forward portion of the medium container 12B. The second small container 12C is stacked on the small container 12C. As illustrated, all the containers 12A, 12B, 12C, 12E in this stack are disposed substantially within the footprint of the extra-large storage container 12E. The left and right sides of the small and medium containers 12C, 12B are all vertically aligned with the respective front and rear sides of the extra-large container 12E. Likewise, the front and rear sides of the large containers 12A are all vertically aligned with the respective front and rear sides of the extra-large container 12E.

Other stacked arrangements for the containers 12A-E are within the scope of the present disclosure.

It is understood the locating structure of the present disclosure can be incorporated into other types/sizes of storage containers so that the locating structure can be used to position the stackable storage containers 12A-E of the present disclosure relative to said other types/sizes of storage containers. Further, it is understood the locating structure of the present disclosure can be incorporated into other objects/items, such as shelves, truck beds, floors, etc. (generally, any object/item which would support the stack of storage containers), to position the stackable storage containers 12A-E of the present disclosure relative to said other object/item.

Having described the disclosure in detail, it will be apparent that modifications and variations are possible without departing from the scope of the disclosure defined in the appended claims. For example, where specific dimensions are given, it is understood these dimensions are exemplary and other dimensions are possible.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above systems and methods without departing from the scope of the disclosure, it is intended that all matter contained in the above description and shown in the accompanying drawings shall be interpreted as illustrative and not in a limiting sense.

What is claimed is:

1. A container system comprising:
a first storage container including a first base, a first lid, and a first storage interior defined by the first base and the first lid, the first base forming a bottom of the first storage container and the first lid forming a top of the first storage container, the first base including a first mating recess on the bottom of the first storage container, the first lid including a first mating projection on the top of the first storage container, the first storage container being of a first size; and
a second storage container including a second base, a second lid, and a second storage interior defined by the second base and the second lid, the second base forming a bottom of the second storage container and the second lid forming a top of the second storage container, the second base including a second mating recess on the bottom of the second storage container, the second lid including a second mating projection on the top of the second storage container, the second storage container being of a second size different than the first size; and
a third storage container including a third base, a third lid, and a third storage interior defined by the third base and the third lid, the third base forming a bottom of the third storage container and the third lid forming a top of the third storage container, the third lid including a plurality of third mating projections on the top of the third storage container, the third storage container being of a third size different than the second size and the first size;
the first, second, and third storage containers being configured to be arranged in a first stacked arrangement and a second stacked arrangement;
wherein in the first stacked arrangement:
the second storage container is stacked on the third storage container such that two third mating projections of the plurality of mating projections of the third storage container are disposed in the second mating recess of the second storage container; and
the first storage container is stacked on the third storage container such that another two third mating projections of the plurality of mating projections of the third storage container are disposed in the first mating recess of the first storage container; and
wherein in the second stacked arrangement:
the second storage container is stacked on the third storage container such that two third mating projections of the plurality of mating projections of the third storage container are disposed in the second mating recess of the second storage container; and
the first storage container is stacked on the second storage container such that the second mating projection of the second storage container is disposed in the first mating recess of the first storage container.

2. The container system of claim 1, wherein in the first stacked arrangement the first and second storage containers are disposed substantially within a footprint of the third storage container.

3. The container system of claim 1, wherein in the second stacked arrangement the second storage container is disposed substantially within a footprint of the third storage container and the first storage container is disposed substantially within a footprint of the second storage container.

4. The container system of claim 1, wherein in the first and second stacked arrangements a left side of the second storage container is substantially vertically aligned with a rear side of the third storage container and a right side of the second storage container is substantially vertically aligned with a front side of the third storage container.

5. The container system of claim 1, wherein in the first and second stacked arrangements a left side of the first storage container is substantially vertically aligned with the rear side of the third storage container and a right side of the first storage container is substantially vertically aligned with the front side of the third storage container.

6. The container system of claim 1, wherein in the first and second stacked arrangements the two third mating projections of the plurality of mating projections of the third storage container are configured to inhibit the second storage container from moving forward and rearward relative to the third storage container.

7. The container system of claim 1, wherein in the first stacked arrangement said another two third mating projections of the plurality of mating projections of the third storage container are configured to inhibit the first storage container from moving forward and rearward relative to the third storage container.

8. The container system of claim 1, wherein in the second stacked arrangement the second mating projection of the second container is configured to inhibit the first storage container from moving forward and rearward relative to the third storage container.

9. The container system of claim 1, wherein the third base of the third container includes a third mating recess on the bottom of the third storage container, the third mating recess being sized and shaped to receive a plurality of third mating projections of another storage container identical to the third storage container.

10. The container system of claim 1, wherein the plurality of third mating projections comprises four mating projections spaced apart from one another and arranged in a 2×2 grid.

11. The container system of claim 1, wherein the first lid is free of one or more additional mating projections and the first base is free of one or more additional mating recesses.

12. The container system of claim 1, wherein the second lid is free of one or more additional mating projections and the second base is free of one or more additional mating recesses.

13. The container system of claim 1, wherein the first mating recess has an open side.

14. The container system of claim 13, wherein in the first stacked arrangement said another two third mating projections of the plurality of mating projections of the third storage container extend out of the first mating recess of the first storage container via the open side.

15. The container system of claim 13, wherein in the second stacked arrangement the second mating projection of the second storage container extends out of the first mating recess of the first storage container via the open side.

16. The container system of claim 1, wherein the second size is larger than the first size, and the third size is larger than the second size.

17. The container system of claim 1, wherein in the first and second stacked arrangements a front side of the second storage container is substantially vertically aligned with a front side of the third storage container and a rear side of the second storage container is substantially vertically aligned with a rear side of the third storage container.

18. The container system of claim 1, wherein in the first and second stacked arrangements a front side of the first storage container is substantially vertically aligned with a rear side or a front side of the third storage container.

19. The container system of claim 1, further comprising a fourth storage container including a fourth base, a fourth lid, and a fourth storage interior defined by the fourth base and the fourth lid, the fourth base forming a bottom of the fourth storage container and the fourth lid forming a top of the fourth storage container, the fourth lid including a plurality of fourth mating projections on the top of the fourth storage container, the fourth storage container being of a fourth size different than each of the first, second, and third sizes;
wherein the third base of the third container includes a third mating recess on the bottom of the third storage container; and
wherein the fourth container is configured to be arranged with the first, second, and third storage containers in at least one of the first stacked arrangement or the second stacked arrangement, wherein in said at least one of the first stacked arrangement or the second stacked arrangement the third storage container is stacked on the fourth storage container such that four fourth mating projections of the plurality of fourth mating projections of the fourth storage container are disposed in the third mating recess of the third storage container.

20. The container system of claim 19, wherein the fourth base of the fourth container includes a fourth mating recess on the bottom of the fourth storage container, the fourth mating recess being sized and shaped to receive a plurality of fourth mating projections of another storage container identical to the fourth storage container.
